(19) United States
(12) Patent Application Publication
(10) Pub. No.: US 2020/0082160 A1
(43) Pub. Date: Mar. 12, 2020

(54) FACE RECOGNITION MODULE WITH ARTIFICIAL INTELLIGENCE MODELS

(71) Applicant: Kneron (Taiwan) Co., Ltd., Taipei City (TW)

(72) Inventors: Hsiang-Tsun Li, Taichung City (TW); Bike Xie, San Diego, CA (US); JUNJIE SU, San Diego, CA (US)

(21) Appl. No.: 16/528,642

(22) Filed: Aug. 1, 2019

Related U.S. Application Data
(60) Provisional application No. 62/730,496, filed on Sep. 12, 2018.

(51) Int. Cl. G06K 9/00; G01N 21/359; G06N 3/02

(52) U.S. Cl. CPC G06K 9/00288; G06N 3/02; G01N 21/359; G06K 9/00281

(57) ABSTRACT

A face recognition module includes a near infrared flash, a master near infrared camera, an artificial intelligence NIR image model, an artificial intelligence original image model, and an artificial intelligence fusion model. The NIR flash flashes near infrared light. The master near infrared camera captures a NIR image. The artificial intelligence NIR image model processes the NIR image to generate NIR features. The artificial intelligence original image model processes a 2 dimensional second camera image to generate face features or color features. The artificial intelligence fusion model generates 3 dimensional face features, a depth map and an object's 3 dimensional model according to the NIR features, the face features and the color features.

### CROSS REFERENCE TO RELATED APPLICATIONS

This application claims the benefit of U.S. Provisional Application No. 62/730,496, filed Sep. 12, 2018 which is incorporated herein by reference.

### BACKGROUND OF THE INVENTION

### 1. Field of the Invention

The present invention relates to face recognition, and more particularly to a module and method for face recognition according to artificial intelligence models.

### 2. Description of the Prior Art

Digital cameras now can obtain 2D color images with high resolution. Although traditional 2D recognition technology can analyze red, green, and blue (RGB) colors to track human face features, the success rate is still easily affected by the camera shooting angle and the brightness of ambient light. Compared with 2D recognition, three dimensional (3D) recognition captures depth information and is unaffected by ambient light changes.

The three dimensional (3D) recognition uses 3D sensors to capture depth information. The most popular 3D recognition technologies are time of flight camera and structured light. The time of flight camera employs time of flight technique to resolve distance between the camera and the object for each point of the image. The time of flight image can provide depth information to establish object's 3D model. The disadvantage of time of flight camera is low resolution. The current mainstream TOF sensor available on mobile device is relatively low (130*240, 240*480 etc.). Therefore, the accuracy at close range is also relatively low. In addition, the power consumption and heat generation of components are relatively large at work. Long-term work requires good heat dissipation conditions.

The structured light is an active depth sensing technology. The basic components of the structured light include an infrared (IR) projector, infrared camera, RGB camera, etc. The infrared projector emits an original light pattern to the object, and then the light pattern reflected by the surface of the object is received by the infrared camera. The reflected light pattern is compared and contrasted with the original light pattern, and the object's 3 dimensional coordinates are calculated according to the trigonometric principle. The disadvantage of structure light is it needs many fixed-position instruments and the instruments are not portable.

### SUMMARY OF THE INVENTION

An embodiment discloses a face recognition module. The face recognition module comprises a near infrared (NIR) flash configured to flash near infrared light, a master near infrared camera for capturing a NIR image, an artificial intelligence NIR image model configured to process the NIR image to generate NIR features, an artificial intelligence original image model configured to process a 2 dimensional second camera image to generate face features or color features, and an artificial intelligence fusion model configured to generate 3 dimensional face features, a depth map and an object's 3 dimensional model according to the NIR features and the color features.

Another embodiment discloses a face recognition method. The face recognition method comprises adjusting an exposure of an face recognition module, a master near infrared (NIR) camera of the face recognition module capturing a NIR image, an artificial intelligence NIR image model of the face recognition module processing the NIR image to generate NIR features according to pre-loaded NIR patterns, an artificial intelligence original image model of the face recognition module processing a 2 dimensional second camera image to generate face features or color features according to pre-loaded color patterns, and an artificial intelligence fusion model of the face recognition module generating 3 dimensional face features, a depth map and an object's 3 dimensional model according to the NIR features, the color features and pre-loaded 3 dimensional feature patterns.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates an embodiment of a face recognition module.

FIG. 2 illustrates an embodiment of a face recognition module connected to a mobile device.

FIG. 3 is a flowchart of a face recognition method according to an embodiment.

FIG. 4 illustrates an embodiment of an application executed on an operating system of the mobile device in FIG. 2.

### DETAILED DESCRIPTION

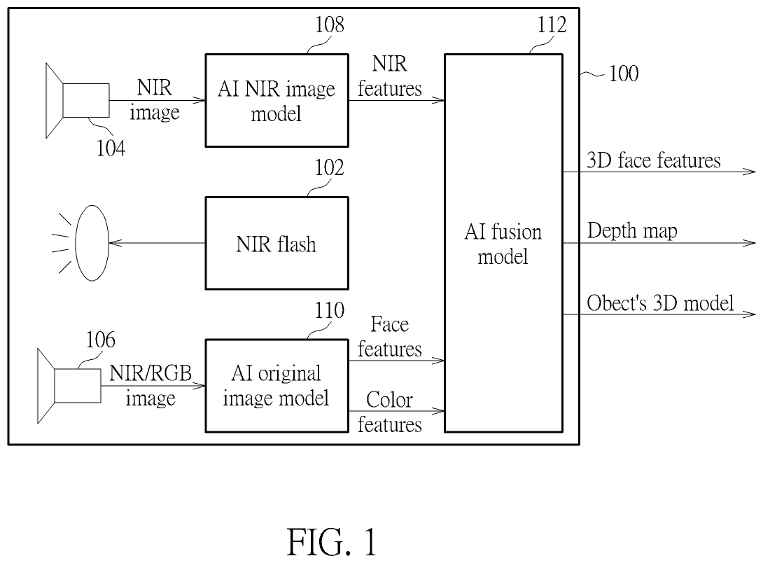

FIG. 1 shows an embodiment of a face recognition module 100. The face recognition module 100 comprises a near infrared (NIR) flash 102, a master near infrared camera 104, a second camera 106, an artificial intelligence (AI) NIR image model 108, an artificial intelligence (AI) original image model 110, and an artificial intelligence (AI) fusion model 112. The NIR flash 102 is used to flash near infrared light. The master NIR camera 104 is used to capture a NIR image. The artificial intelligence (AI) NIR image model 108, the artificial intelligence (AI) original image model 110, and the artificial intelligence (AI) fusion model 112 are executed on a central processing unit (CPU) and/or graphics processing unit (GPU) of the face recognition module 100. The AI NIR image model 108 is used to process the NIR image to generate NIR features. The second camera 106 captures a 2 dimensional second camera image. The second camera image comprises an NIR image or a red, green, blue (RGB) color image. The AI original image model 110 is used to process the 2 dimensional second camera image to generate face features or color features. The AI fusion model 112 is used to generate 3 dimensional (3D) face features, a depth map and an object's 3D model according to the NIR features, the face features, and the color features.

The near infrared flash 102 can be a light emitting diode (LED) flash or a laser flash. The near infrared (NIR) is electromagnetic radiation with longer wavelengths than visible light. That's why the NIR can detect people, animal or other moving objects in the dark. In one embodiment, the near infrared flash 102 emits laser or near infrared to help the face recognition module 100 capture the NIR images. The near infrared flash 102 can be an NIR 940 laser flash, NIR 850 laser flash, NIR 940 LED flash or NIR 850 LED flash.

The master NIR camera 104 captures NIR images. The NIR wavelength is outside the range of what humans can see and can offer clearer details than what is achievable with visible light image. The NIR image is especially capable to capture images in dark or insufficient light. The longer wavelengths of the NIR spectrum are able to penetrate haze, light fog, smoke and other atmospheric conditions better than visible light. So the NIR image can provide sharper, less distorted image with better contrast than visible color image.

The second camera 106 captures 2 dimensional second camera images. In this embodiment, the second camera 106 is a component of the face recognition module 100. The 2 dimensional second camera images comprise NIR images or color images. The second camera 106 captures images depending on what it is used for. For example, if the second camera 106 is used for detecting objects or human in the dark, it will be set to capture the NIR images. If the second camera is used for color face recognition, it will be set to capture red, green, and blue (RGB) color images.

Three artificial intelligence (AI) models are used in the face recognition module 100. The AI NIR image model 108 processes NIR images to generate NIR features. For moving object, the depth information of moving object can be determined by using only one AI NIR camera. The master NIR camera 104 can capture images of a moving object and the AI NIR image model 108 can compute the object's depth information by calculating the relative motion between the master NIR camera 104 and the object.

The AI original image model 110 processes 2D NIR images or 2D color images to generate face features or color features. The AI fusion model 112 generates 3D face features, a depth map and an object's 3D model according to NIR features, face features, and color features. The depth map and the object's 3D model are generated by stereo vision technology. Stereo vision is based on the principle of parallax of human eye. The master NIR camera 104 and the second camera 106 acquire images from different angles. The 3D coordinates of the visible points on the object surface can be determined based on two or more images that are acquired from different points of view. This is done by calculating the disparity map of these images. Then, the depth map and object's 3D model is determined.

According to the 3D face features, the depth map, and the object's 3D model, the face recognition module 100 can provide better recognition accuracy than traditional 2D recognition. For example, 3D face recognition has the potential to achieve better accuracy than 2D by measuring geometric features on the face. With 3D face recognition, features which could not be recognized by 2D face recognition, such as light changes, different facial expressions, shaking head, make up on face, etc., can be recognized. Furthermore, because facial expressions in 3D face are different from 2D, 3D face recognition can provide liveness detection according to the 3D model, 3D features, and can verify if facial expression is natural. Furthermore, since the second camera 106 can capture the NIR images which contain thermal information of human or animal, liveness detection can be easily implemented.

Because the AI fusion model 112 generates depth information in real time, the face recognition module 100 can track the movements of the object. The master NIR camera 104 captures and forwards continuous NIR images to the AI NIR image model 108 to generate the depth maps. The depth maps can be used to extract the object in the continuous images to identify if the object is moving.

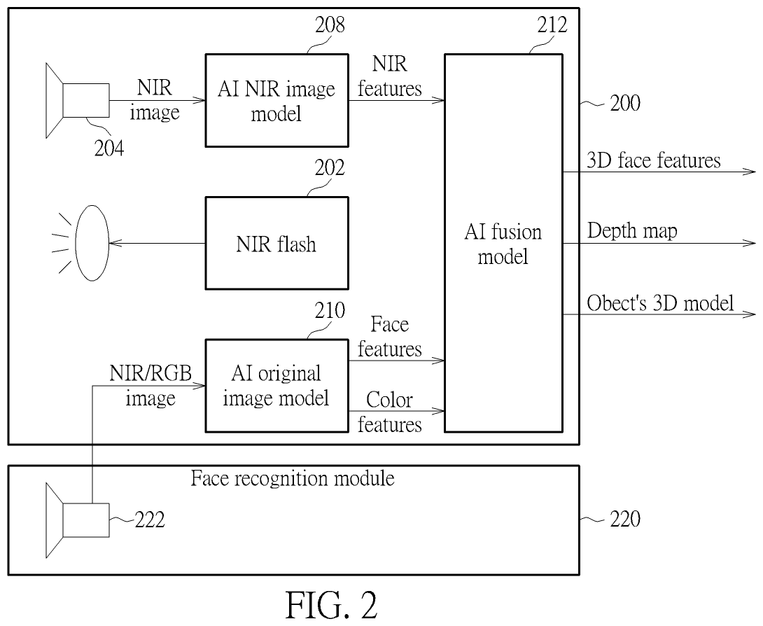

FIG. 2 shows an embodiment of a face recognition module 200 connected to a mobile device 220. The face recognition module 200 can be a portable module. The mobile device 220 can be a mobile phone, video camera, video recorder, tablet, handheld computer, or any device with at least one camera. The face recognition module 200 comprises an NIR flash 202, a master near infrared camera 204, an artificial intelligence (AI) NIR image model 208, an artificial intelligence (AI) original image model 210, and an artificial intelligence (AI) fusion model 212. The master near infrared camera 204 of the face recognition module 200 is used to capture NIR images. The mobile device 220 comprises a camera 222 used to capture 2 dimensional second camera images comprising NIR images or RGB color images. The AI NIR image model 208 is used to process the NIR image to generate face features and a depth map. The AI original image model 210 is used to process second camera images to generate face features or color features. The AI fusion model 212 is used to generate 3D face features, a depth map and an object's 3D model according to the NIR features, the face features, and the color features.

When the NIR flash 202 illuminates, the master NIR camera 204 of the face recognition module 200 captures a NIR image. At the same time, the camera 222 of the mobile device 220 captures an NIR image or RGB color image. According to the NIR image, the AI NIR image model 208 generates NIR features. According to the NIR images or color images, the AI original image model 210 generates face features or color features. Because the master NIR camera 104 and the second camera 106 acquire images from different angles, the AI fusion model 212 can calculate the disparity maps of the object according to different angle images. The AI fusion model 212 generates 3D face features and a depth map according to the disparity maps. The AI fusion model 212 also generates the object's 3D model.

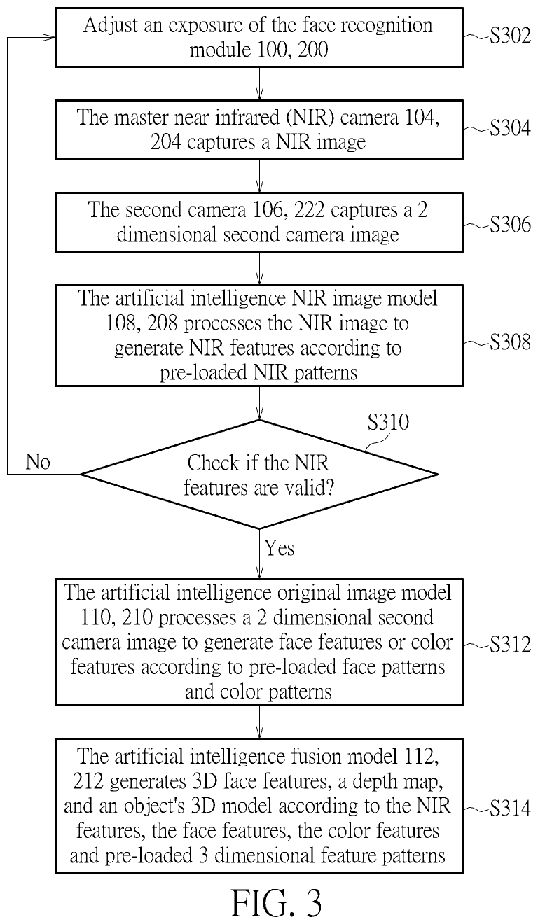

FIG. 3 is a flowchart of a face recognition method according to an embodiment. The method comprises the following steps:

Step S302: adjust an exposure of the face recognition module 100, 200;

Step S304: the master near infrared (NIR) camera 104, 204 captures a NIR image;

Step S306: the second camera 106, 222 captures a 2 dimensional second camera image;

Step S308: the artificial intelligence NIR image model 108, 208 processes the NIR image to generate NIR features according to pre-loaded NIR patterns;

Step S310: check if the NIR features are valid? If so, go to Step S312; else go to Step S302;

Step S312: the artificial intelligence original image model 110, 210 processes a 2 dimensional second camera image to generate face features or color features according to pre-loaded face patterns and color patterns; and

Step S314: the artificial intelligence fusion model 112, 212 generates 3D face features, a depth map, and an object's 3D model according to the NIR features, the face features, the color features and pre-loaded 3 dimensional feature patterns.

In Step S302, the exposure control of the face recognition module 100, 200 comprises adjusting the NIR flash 102, 202, the master NIR camera 104, and the second camera 106, 222. In one embodiment, the second camera 106 is in the face recognition module 100. In another embodiment, the second camera 222 is in the mobile device 220 connected with the face recognition module 200. The exposure control of the NIR flash 102, 202 comprises controlling flash light intensity and controlling the flash light duration. The exposure control of the master NIR camera 104, 204 comprises controlling the aperture, the shutter and automatic gain control. The exposure control of the second camera 106, 222 comprises controlling the aperture, the shutter and automatic gain control. When the NIR flash 102, 202 provides enough luminance, the master NIR camera 104, 204 and the second camera 106, 222 adjust the shutter speed and lens' aperture to capture images. Automatic gain control is a form of amplification to boost the image to let the object in the image be seen more clearly. When the light quality drops below a certain level, the camera will boost the signals in the image to compensate for the lack of light. Through flash controls, aperture controls, shutter controls, and gain controls, good quality images can be obtained for face recognition.

In one embodiment, the face recognition module 100, 200 uses convolution neural network (CNN) as the major face recognition technology. In Step S312, the AI original image model 110, 210 pre-loads face patterns and color patterns. These patterns can be 2D patterns trained by large scale 2D images according to the convolution neural network (CNN) algorithm. For example, the face patterns and color patterns include ears, eyes, lips, skin colors, Asian face shapes, etc. to help increase the 2D face recognition accuracy. The performance of 2D face recognition will be increased by leveraging CNN's characterization capability and large-scale labeled CNN trained data. In step S308, the AI NIR image model 108, 208 also pre-loads NIR patterns. The NIR patterns are trained by large scale NIR images according to the CNN algorithm. (The NIR patterns include labeled NIR features of object to increase the face recognition accuracy.) The generated NIR features in Step S308 and the color features in Step S312 are sent to step S314 for 3D face recognition.

In step S310, if the AI NIR image model 108, 208 can't generate valid NIR features, it will go back to step S302 and then adjust the exposure of the face recognition model 100, 200 to capture a NIR image again. In another embodiment, if the AI original image model 110, 210 can't generate valid color features, it will go back to step 302 and then adjust the exposure of the face recognition model 100, 200 to capture the second camera images again.

In step S314, because the master NIR camera 104 and the second camera 106 acquire images from different angles, the disparity maps of these images can be calculated. The AI fusion model 112, 212 generates 3D features, the depth map and the object's 3D model according to the NIR features, the face features, the color features, disparity maps and the pre-loaded 3D feature patterns. The AI fusion model 112, 212 pre-loads the AI 3D feature patterns which are trained by convolution neural network algorithm to increase the 3D recognition accuracy. The 3D face features and the depth map can be used to construct the object's 3D model. Compared with 2D recognition, the establishment of the object's 3D model has many advantages. The 3D human face model has more potential to improve the accuracy of face recognition under some challenging situations. For example, the low-resolution photos are difficult to identify a human face and it is not easy to use 2D features to identify a human being who changes facial expressions. With the availability of 3D human face model, which is inherently insensitive to illumination, pose changes, different angle of view, these complications can be dealt with efficiently by 3D human face model.

The artificial intelligence fusion model 112, 212 further comprises functions of AI face detection, AI landmark generation, AI quality detection, AI depth map generation, AI liveness detection and/or AI face feature generation according to the 3D face features, the depth map, and object's 3D model. This means the face recognition module 100, 200 can actively provide the above functions for the user to use.

In step S308, S312, and S314, the convolution neural network (CNN) or the recurrent neural network can be used as the main face recognition technology in the AI NIR image model 108, 208, the AI original image model 110, 210, and the AI fusion model 112, 212. The convolution neural network (CNN) or recurrent neural network in different steps can be combined to optimize face recognition accuracy. For example, but not limited to, the face recognition technology in step S308 and S312 can be the convolution neural network and the face recognition technology in step S314 can be the recurrent neural network.

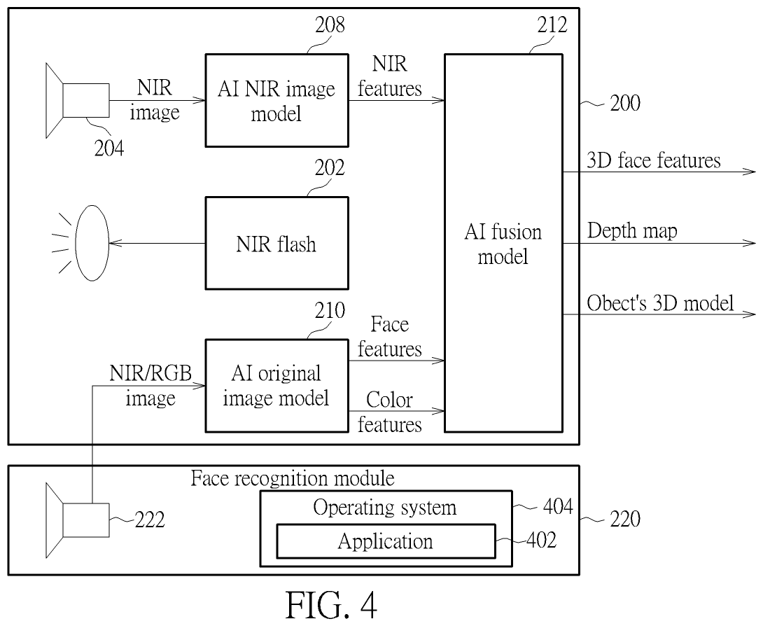

FIG. 4 shows an embodiment of an application 402 executed on an operating system 404 of the mobile device 220. In FIG. 4, the face recognition module 200 is connected with the mobile device 220. The application 402 comprises functions of AI face detection, AI landmark generation, Al quality detection, AI depth map generation, AI liveness detection and/or AI face feature generation. The application 402 receives 3D face features, a depth map and an object's 3D model from the AI fusion model 212 for face recognition. In one embodiment, the application 402 can be an Android application (APP) or i-phone APP running on the operating system of the mobile device.

The embodiments provide systems and methods for face recognition. The face recognition module can be portable and can connect with a mobile device such as mobile phone, video camera, etc. When the NIR flash emits near infrared light, the master NIR camera and the second camera captures images. The master NIR camera captures NIR images and the second camera captures NIR or color images. Three AI models are used in the face recognition module, including the AI NIR image model processing the NIR image, the AI original image model processing the NIR or color images, and the AI fusion model generating 3D face features, depth map and object's 3D model. The face recognition module pre-loads the trained AI patterns to increase the face recognition successful rate and optimize the extracted features. The generated 3D face features, depth maps, and object's 3D model can be used for AI face detection, AI face feature generation, AI landmark generation, AI liveness detection, AI depth map generation, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A face recognition module comprising:
a near infrared (NIR) flash configured to flash near infrared light;
a master near infrared (NIR) camera for capturing a NIR image;
an artificial intelligence NIR image model configured to process the NIR image to generate NIR features;
an artificial intelligence original image model configured to process a 2 dimensional second camera image to generate face features or color features; and
an artificial intelligence fusion model configured to generate 3 dimensional face features, a depth map and an object's 3 dimensional model according to the NIR features, the face features, and the color features.

2. The module of claim 1, wherein the near infrared flash is an NIR 940 laser flash, NIR 850 laser flash, NIR 940 LED flash or NIR 850 LED flash.

3. The module of claim 1 further comprising a second camera for capturing the 2 dimensional second camera image.

4. The module of claim 3, wherein the second camera image comprises an NIR image or a red, green, blue (RGB) color image.

5. A face recognition method comprising:
adjusting an exposure of a face recognition module;
a master near infrared (NIR) camera of the face recognition module capturing a NIR image;
an artificial intelligence NIR image model of the face recognition module processing the NIR image to generate NIR features according to pre-loaded NIR patterns;
an artificial intelligence original image model of the face recognition module processing a 2 dimensional second camera image to generate face features or color features according to pre-loaded face patterns and color patterns; and
an artificial intelligence fusion model of the face recognition module generating 3 dimensional face features, a depth map and an object's 3 dimensional model according to the NIR features, the face features, the color features and pre-loaded 3 dimensional feature patterns.

6. The method of claim 5 further comprising a second camera capturing the 2 dimensional second camera image.

7. The module of claim 6, wherein the second camera image comprises an NIR image or a red, green, blue (RGB) color image.

8. The method of claim 5, further comprising:
the artificial intelligence NIR image model pre-loading the NIR patterns;
the artificial intelligence original image model pre-loading the face patterns and color patterns; and
the artificial intelligence fusion model pre-loading the 3 dimensional feature patterns.

9. The method of claim 5, wherein adjusting the exposure of the face recognition module comprises:
controlling flash intensity of an infrared light emitting diode (LED) flash, controlling a flash duration of the infrared LED flash, controlling an aperture of the master near infrared camera, controlling an aperture of the second camera and/or controlling automatic gain control of the face recognition module.

10. The method of claim 5 further comprising the artificial intelligence fusion model performing artificial intelligence face detection, artificial intelligence landmark generation, artificial intelligence quality detection, artificial intelligence depth map generation, artificial intelligence liveness detection and/or artificial intelligence face feature generation according to the 3 dimensional face features, the depth map and the object's 3 dimensional model.

11. The method of claim 5 further comprising an application performing artificial intelligence face detection, artificial intelligence landmark generation, artificial intelligence quality detection, artificial intelligence depth map generation, artificial intelligence liveness detection and/or artificial intelligence face feature generation according to the 3 dimensional face features, the depth map and the object's 3 dimensional model.

12. The method of claim 5, wherein the artificial intelligence NIR image model is a convolution neural network model or a recurrent neural network model.

13. The method of claim 5, wherein the artificial intelligence original image model is a convolution neural network model or a recurrent neural network model.

14. The method of claim 5, wherein the artificial intelligence fusion model is a convolution neural network model, or a recurrent neural network model.
